(19) United States
(12) Patent Application Publication
(10) Pub. No.: US 2011/0135362 A1
(43) Pub. Date: Jun. 9, 2011

(54) Image forming apparatus and method for de-skewing thereof

(75) Inventor: Won-kyoung Cho, Suwon-si (KR)

(73) Assignee: SAMSUNG ELECTRONICS CO., LTD., Suwon-si (KR)

(21) Appl. No.: 12/662,998

(22) Filed: May 14, 2010

(30) Foreign Application Priority Data
Dec. 7, 2009 (KR) 2009-0120508

(51) Int. Cl. G03G 15/00

(52) U.S. Cl. 399/372

(57) ABSTRACT

An image forming apparatus includes an input unit to receive an image of a print media fed through an automatic document feeder (ADF), a first storage unit to store the input image as predetermined data form, a computing unit to detect a lead edge of the print media and compute a skew level of the input image, a skew correcting unit to read the stored data through a direct memory access (DMA) processing, and carry out de-skewing with respect to the input image according to the computed skew level, an image processing unit to carry out image processing with respect to the de-skewed image, and an output unit to output the resultant image of the image processing. As a result, efficient processing of de-skewing is provided.

### CROSS-REFERENCE TO RELATED APPLICATIONS

This application claims priority under 35 U.S.C. §119 (a) from Korean Patent Application No. 10-2009-0120508, filed on Dec. 7, 2009, in the Korean Intellectual Property Office, the disclosure of which is incorporated herein by reference in its entirety.

### BACKGROUND

1. Field

The present general inventive concept relates to an image forming apparatus and a method for de-skewing thereof. More particularly, the present general inventive concept relates to an image forming apparatus and a method for de-skewing thereof, which correct skew of a printing media fed by an automatic document feeder (ADF).

2. Description of the Related Art

An image forming apparatus, such as a printer, a scanner, a copier, a facsimile, or a multiple function unit (MFU) integrating the functions of the apparatuses mentioned above, generally operates to create, print, or receive or transmit image data.

Among the above, an image forming apparatus with an automatic document feeder (ADF) is generally equipped with a feature to prevent skewing of a printing media by physically guiding the printing media. However, a printing media sheet still may be skewed as it travels along a printing path, mainly due to problems associated with different diameters of, or different degrees of frictional force applied between left and right rollers of the ADF.

If the document fed by the ADF is skewed before scanning or copying, a user of the image forming apparatus has the skewed image result, which is inappropriate for use. Accordingly, there exists a need for correcting a skew generated by the ADF.

Although there have been many suggestions to correct the abovementioned skew problem, most of those suggestions involve a need for an increased number of accesses to an external memory, which subsequently deteriorates system performance, or results in a unsatisfactory image quality of a reproduction of the de-skewed document.

### SUMMARY

The present general inventive concept provides an image forming apparatus and a method for de-skewing thereof, capable of adjusting an amount of data unit for direct memory access (DMA) processing in accordance with a level of skewing.

Additional aspects and/or advantages will be set forth in part in the description which follows and, in part, will be apparent from the description, or may be learned by practice of the invention.

The foregoing and/or other aspects and utilities may be achieved by providing an image forming apparatus, which may include an input unit to receive an image of a print media fed through an automatic document feeder (ADF), a first storage unit to store the input image as predetermined data form, a computing unit to detect a lead edge of the print media and compute a skew level of the input image, a skew correcting unit to read the stored data through a direct memory access (DMA) processing, and carry out de-skewing with respect to the input image according to the computed skew level, an image processing unit to carry out image processing with respect to the de-skewed image, and an output unit to output the resultant image of the image processing.

The first storage unit stores the input image in a burst unit of data, and the skew correcting unit adjusts the burst unit based on the computed skew level and reads the stored data based on the adjusted burst unit through the DMA processing.

The skew correcting unit reduces the burst unit if the computed skew level exceeds a reference value.

The skew correcting unit may include an image rotating unit to adjust the burst unit based on the computed skew level, reads the stored data in the adjusted burst unit through the DMA processing, and rotate the image, and an interpolating unit to interpolate difference of lightness values occurring due to rotating of the image, with respect to each of the pixels constituting the rotated image.

The input image is a contone image, and the skew correcting unit carries out de-skewing with respect to the contone image.

The first storage unit is a dynamic random access memory (DRAM).

The image forming apparatus may additionally include a shading correcting unit to correct a difference of lightness values of the input image in a primary scanning direction, and a gamma correcting unit to linearly corrects the image of which difference of lightness values is corrected.

The image forming apparatus may additionally include a second storage unit to store data about the computed skew level, wherein the skew correcting unit carries out de-skewing using the data about the skew level stored in the second storage unit.

The foregoing and/or other aspects and utilities may also be achieved by providing a method of de-skewing of an image forming apparatus, which may include receiving an image of a print media fed through an automatic document feeder (ADF), storing the input image as predetermined data form, detecting a lead edge of the print media and computing a skew level of the input image, reading the stored data through a direct memory access (DMA) processing, and carrying out de-skewing with respect to the input image according to the computed skew level, carrying out image processing with respect to the de-skewed image, and outputting the resultant image of the image processing.

The storing may include storing the input image in a burst unit of data, and the reading the stored data through DMA processing and carrying out de-skewing comprises adjusting the burst unit of the data based on the computed skew level and reading the stored data in the adjusted burst unit through the DMA processing.

The reading the stored data through DMA processing and carrying out de-skewing may include reducing the burst unit if the computed skew level exceeds a reference value.

The reading the stored data through DMA processing and carrying out de-skewing may include adjusting the burst unit based on the computed skew level, reading the stored data in the adjusted burst unit through the DMA processing, and rotating the image, and interpolating difference of lightness values occurring due to rotating of the image, with respect to each of the pixels constituting the rotated image.

The input image is a contone image, and the reading the stored data through DMA processing and carrying out de-skewing may include carrying out de-skewing with respect to the contone image.

The method of de-skewing may additionally include correcting a difference of lightness value of the input image in a primary scanning direction, and linearly correcting the image of which difference of lightness values is corrected.

The method of de-skewing may additionally include storing data about the computed skew level, wherein the reading the stored data through DMA processing and carrying out de-skewing may include carrying out de-skewing using the stored data about the skew level.

The foregoing and/or other aspects and utilities may also be achieved by providing an image forming apparatus, which may include a scanning unit to scan an image of a print media fed through an automatic document feeder (ADF), a memory to store the input image in a burst unit of data, a processor to read the stored data through a direct memory access (DMA) processing, carry out de-skewing with respect to the input image according to the computed skew level, and carry out image processing with respect to the de-skewed image, and a printing unit to output the resultant image of the image processing.

The memory stores the input image in the burst unit of data, and the processor adjusts the burst unit of the data based on the computed skew level, and reads the stored data based on the adjusted burst unit through the DMA processing.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 illustrates an image forming apparatus according to an embodiment;

FIG. 2 illustrates an image forming apparatus according to another embodiment;

FIG. 3 illustrates an example of a first storage unit according to an embodiment;

FIG. 4 illustrates operation to detect skewing carried out by a computing unit according to an embodiment;

FIGS. 5A to 5C illustrate operation of an image rotating unit according to an embodiment;

FIG. 6 illustrates an operation of an interpolating unit according to an embodiment; and

FIG. 7 illustrates a flowchart of a method for de-skewing of an image forming apparatus according to an embodiment.

### DETAILED DESCRIPTION

Reference will now be made in detail to the embodiments, examples of which are illustrated in the accompanying drawings, wherein like reference numerals refer to the like elements throughout. The embodiments are described below in order to explain the present general inventive concept by referring to the figures.

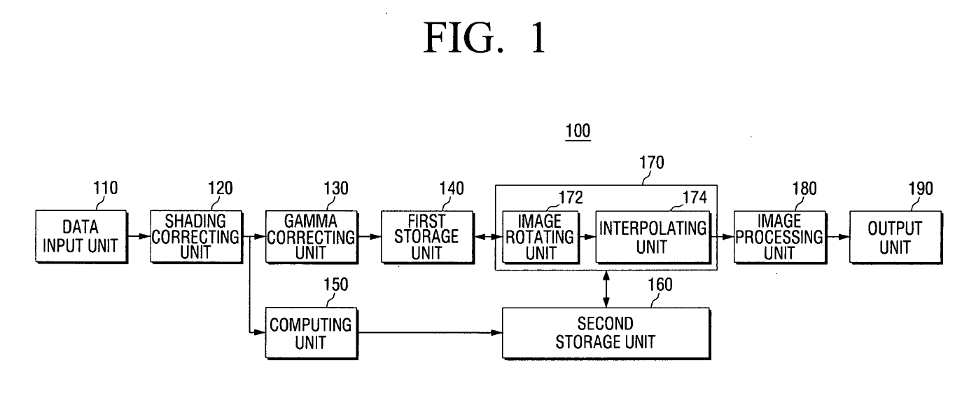

FIG. 1 illustrates an image forming apparatus according to an embodiment.

Referring to FIG. 1, an image forming apparatus 100 includes an input unit 110, a shading correcting unit 120, a gamma correcting unit 130, a first storage unit 140, a computing unit 150, a second storage unit 160, a skew correcting unit 170, an image processing unit 180, and an output unit 190.

Some components 110, 120, 130, 150, 160, 170, 180, 190 of the image forming apparatus 100 may be realized as a processor, and the first storage unit 140 may be realized as an external memory to process the direct memory access (DMA) with the processor.

The input unit 110 receives an image of a printing media sheet fed through an automatic document feeder (ADF). The input unit 110 may include a charge-coupled device (CCD) or constant image sensor (CIS) type image sensor. The printing media may include a scanned image, and pixels of the scanned image may each have a different degree of lightness, that is, gradation.

The shading correcting unit 120 corrects differences of lightness values in a primary scanning direction of the input image. In other words, the shading correcting unit 120 corrects the shading phenomenon which represents different lightness values occurring due to uneven formation of the light by the light source of the image forming apparatus such as a scanner or a copier, in the primary scanning direction of an image.

The gamma correcting unit 130 linearly corrects the image of which differences of lightness values are corrected. Specifically, the gamma correcting unit 130 corrects distortional characteristics which are inherent in the image sensor and expressed in the form of a gamma function.

The first storage unit 140 stores an input image in a predetermined data form. By way of example, the first storage unit 140 may store the data in a burst unit of data. Data has to be arranged in a pixel-wise order, since the pixel data in R, G and B forms have to be input to the output unit 190 for post-processing such as color correction or filtering. Accordingly, the first storage unit 140 is required to buffer the data.

The first storage unit 140 may be realized as a static random access memory (SRAM) provided inside the processor, but it is more desirable that the first storage unit 140 be formed as a dynamic random access memory (DRAM) which has a relatively smaller area. When the DRAM is applied, the first storage unit 140 is able to communicate with the gamma correcting unit 130 or the skew correcting unit 170 via bus, and perform writing or reading according to the operating frequency of the first storage unit 140.

The computing unit 150 detects a lead edge of a printing media sheet and computes a skew level of the input image. Specifically, if the first sheet of printing media is fed in the image forming apparatus 100 according to a command such as a scan command while the image sensor is detecting a white board, the computing unit 110 detects differences of lightness values between a marginal area outside the print media sheet and an outline of the print media sheet (that is, a boundary of the lead edge of the print media sheet). Based on the above, it is determined whether the print media sheet is slant, that is, if skew is occurred.

If it is determined that a source document is sloped, the computing unit 150 may compute a level of skewing, such as a skew angle of the sloped document.

The second storage unit 160 stores a variety of information needed to correct the skew. Specifically, the second storage unit 160 may store data about the computed skew level. Depending on the degree of skewing computed by the computing unit 150, the degree of de-skewing by the skew correcting unit 170 may vary (the de-skewing process will be explained in detail below). Accordingly, the second storage unit 160 stores values necessary for de-skewing in a tabulated form. The second storage unit 160 may be realized in the form of a register within the processor (not illustrated).

The skew correcting unit 170 reads stored data by DMA processing, and performs de-skewing in accordance with the skew level computed with respect to the input image.

Specifically, based on the computed skew level, the skew correcting unit 170 adjusts the burst unit, reads the stored data in the adjusted burst unit by the DMA processing, and de-skews the input image based on the computed skew level. Accordingly, de-skewing is performed fast, using the DMA processing between the external first storage unit 140 and the skew correcting unit 170 of the processor.

The skew correcting unit 170 may correct the skew with respect to a contone image, and thereby avoid degradation of image quality, which was often experienced in a conventional image forming apparatus which corrects skew based on a 2-bit data image.

The skew correcting unit 170 may correct the skew using the data about the skew level stored in the second storage unit 160. The skew correcting unit 170 may also correct the skew using an image processing pipeline.

The skew correcting unit 170 includes an image rotating unit 172 and an interpolating unit 174.

The image rotating unit 172 adjusts the burst unit of the data based on the computed skew level, reads the stored data in the adjusted burst unit by the DMA processing, and rotates the image.

The interpolating unit 174 interpolates the differences of lightness values according to the rotation of the image, with respect to each of the pixels constituting the rotated image.

The image processing unit 180 processes the de-skewed image. Specifically, the image processing unit 180 may perform processing such as color correction, filtering, or rendering of an image appropriately according to the characteristics of the output unit 190, and for more user convenience, the image processing unit 180 may perform various other image processing such as image size adjusting or image quality enhancement.

The image processing unit 180 may also remove a ‘top skip’ which is an unnecessary space on top of the lead edge of the print media sheet, and render the image with the top skip removed.

Accordingly, by correcting a skew with respect to the contone image and performing image processing after the image is de-skewed, the image output quality can be improved from that of the conventional image forming apparatus which performs skew correction with respect to a 2-bit data image.

The output unit 190 outputs a de-skewed image. The output unit 190 may include the image processing unit 180.

The image forming apparatus 100 according to an aspect of the present invention may additionally include a sensor correcting unit (not illustrated) between the image rotating unit 172 and the interpolating unit 174 to operate for the purposes such as correcting of a position, as it becomes necessary while the image reading sensor is operated with respect to the data input in pixel unit through the first storage unit 140.

Additionally, it is desirable that the image forming apparatus 100 may perform a de-skewing function in association with scanning or copying. It is also desirable that the image forming apparatus 100 is a multi function unit (MFU) which feeds print media using ADF, and integrates the functions of either or both of the scanner and the copier.

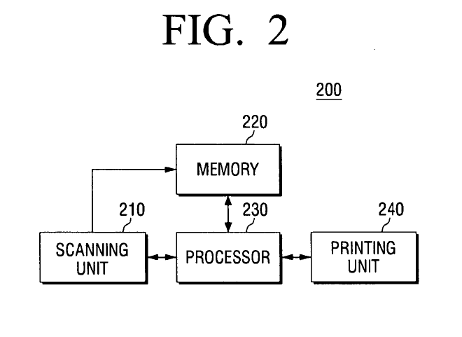

FIG. 2 illustrates an image forming apparatus according to another embodiment. Referring to FIG. 2, the image forming apparatus 200 includes a scanning unit 210, a memory 220, a processor 230, and a printing unit 240.

The scanning unit 210 scans an image on a print media sheet which is fed through the ADF. By way of example, the scanning unit 210 may be a scanning module of the MFU.

The memory 220 stores the input image in the form of predetermined data. Specifically, the memory 220 may store the input image in a burst unit of data.

The memory 220 may be a DRAM located outside the processor, and may operate to store or read the data of the input image in the predetermined burst unit according to the operating frequency of the DRAM.

The processor 230 reads the stored data using the DMA processing, corrects the skew in accordance to the computed skew level with respect to the input image, and processes the de-skewed image.

Specifically, the processor 230 adjusts the burst unit, and reads the stored data in the adjusted burst unit by the DMA processing, based on the computed skew level.

The printing unit 240 outputs the image after image processing. By way of example, the printing unit 240 may be a printing module of a MFU.

Since it is possible to adjust the burst unit of data for processing in the memory 220 based on the skew level, skew is corrected efficiently. Further, image with improved quality is provided, since de-skewing and image processing are performed with respect to a contone image.

Any repetitious explanations will be omitted as much as possible for the sake of brevity.

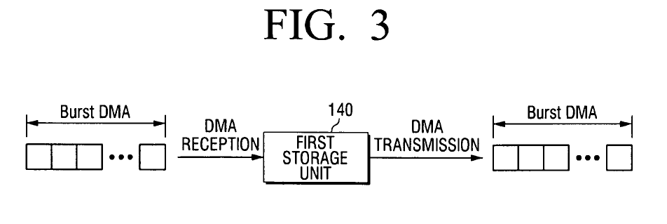

FIG. 3 illustrates an example of the first storage unit according to an embodiment. Referring to FIG. 3, data in burst unit containing a collection of a plurality of pixels is input to the first storage unit 140. Depending on the operating frequency of the first storage unit, the data in burst unit may be input or output in sequence.

The gamma correcting unit 130 (or data input unit 110) may write data on the first storage unit 140 through the direct memory access (DMA) processing. Additionally, the skew correcting unit 170 may read the first storage unit 140 through the DMA processing. Since the DMA processing is utilized and the CPU is not involved in data transmission, the overall performance is improved (for example, processing speed increases).

Meanwhile, since the first storage unit 140 transmits or receives data to or from the gamma correcting unit 130 (or the data input unit 110) and the skew correcting unit 170 via bus (not illustrated), the volume (length) of the data in burst unit may be limited depending on the capacity of the bus (not illustrated).

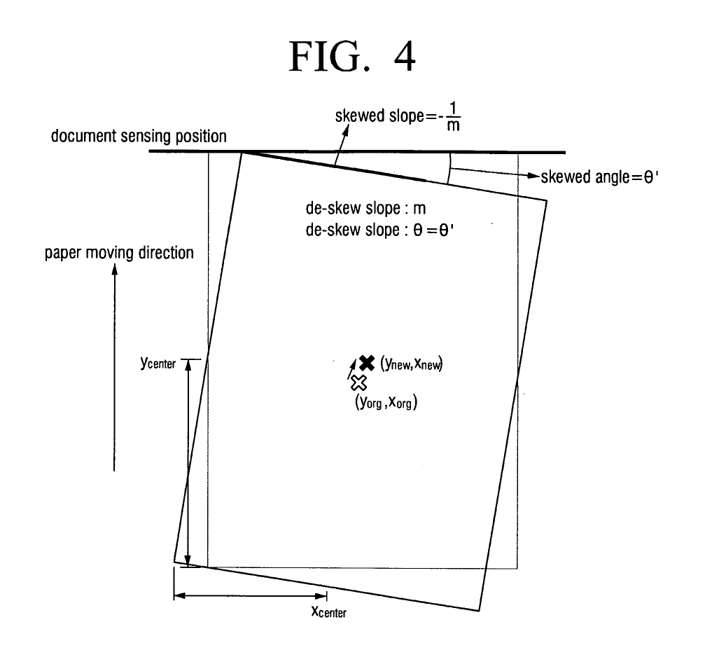

FIG. 4 is provided to explain a skew detection of the computing unit according to an embodiment of the present invention.

Referring to FIG. 4, when a printing media is fed through the ADF, the computing unit 150 begins sensing from the upper edge of the printing media for the presence of skewing, and if determining the presence of skewing, computes a specific form of skew level such as a skew angle.

FIG. 4 illustrates the printing media slant as much as θ′ in the leftward direction. If a print media is slant to the left or right, the computing unit 150 may compute the skew angle. If one is set to be a positive skew angle, then the other is set to be a negative skew angle.

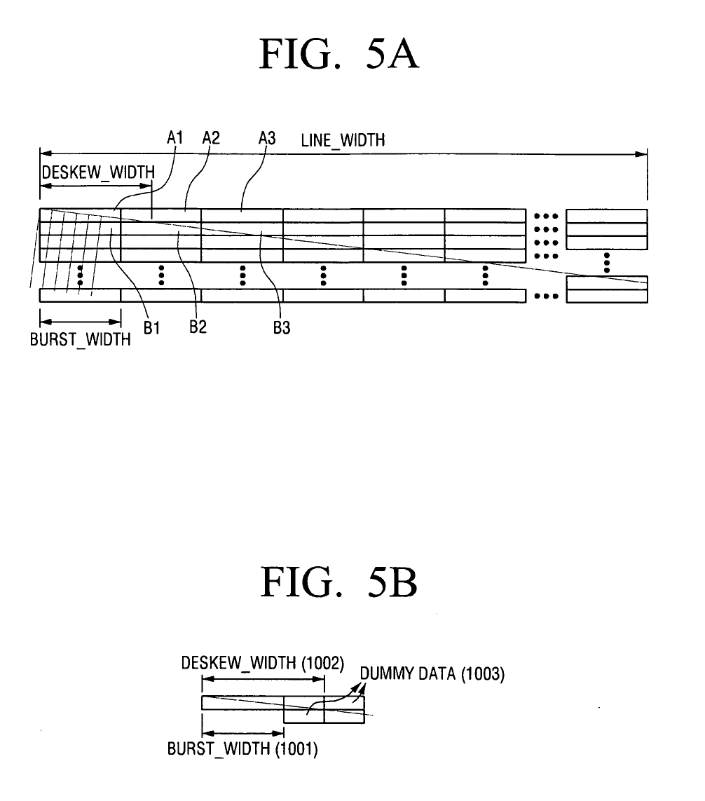

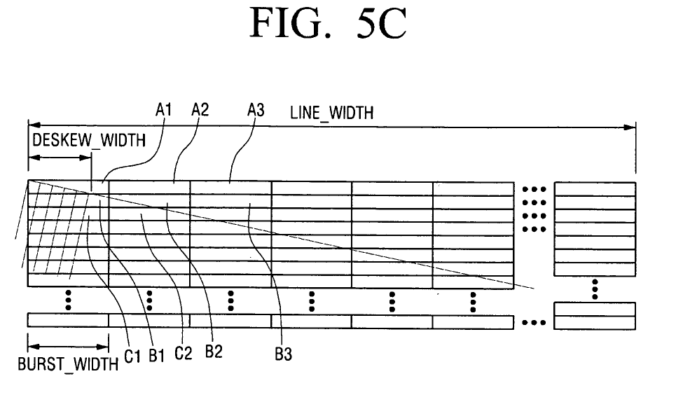

FIGS. 5A to 5C are provided to explain operation of the image rotating unit according to an embodiment of the present invention.

Referring to FIG. 5A, if a print media is not slanted, the image rotating unit 172 reads the data from the first storage unit 140 in the order of pixels A1, A2, A3, . . . , B1, B2, B3, . . . .

If the print media is slanted, the image rotating unit 172 reads data from the first storage unit 140 in the order of pixels A1, A2, B2, B3, . . . which are located on a line (i.e., diagonal line of FIG. 5A) where the skew is generated.

In the abovementioned case, the image rotating unit 172 computes coordinates of each pixel which is moved according to the skew angle computed after the skew is generated, using:

x_{new}=−sin θ*(x_{org}−x_{center})+cos θ*(y_{org}−y_{center})+x_{center}

y_{new}=cos θ*(x_{org}−x_{center})+sin θ*(y_{org}−y_{center})+y_{center} [Mathematical formula 1]

where, X_{new}, Y_{new} represent X and Y coordinates of each pixel after rotation, X_{org}, Y_{org} represent X and Y coordinates of each pixel before rotation, X_{center}, Y_{center} represent X and Y coordinates of each center pixel of a print media, and θ represents skew angle.

After the above, the image rotating unit 172 completes image rotation, by sequentially storing the coordinates of each of the pixels computed by Mathematical formula 1 into the second storage unit 160.

Referring to FIG. 5B, the burst unit (BURST_WIDTH 1001) of the data read from the first storage unit 160 by DMA processing, is larger than the unit (DESKEW_WIDTH 1002) by which line is changed due to the skew angle. This represents the fact that there is almost no skew occurring. Depending on the skew, DUMMY DATA 1003 which is not actually used in the data read by DMA processing may be generated.

Since the skew level of FIG. 5B is relatively smaller, there is relatively smaller amount of DUMMY DATA for processing. FIG. 5C illustrates a relatively higher skew level and in this case, there is greater DESKEW_WIDTH than BURST_WIDTH.

Accordingly, the amount of DUMMY DATA for processing increases and it takes longer time for the image rotating unit 172 to carry out data processing.

In the abovementioned case, the skew correcting unit 170, and particularly the image rotating unit 172 may shorten the processing time for DUMMY DATA, by reducing the burst unit if the computed skew level exceeds a reference value.

The reference value may be empirical data or may be preset by a user.

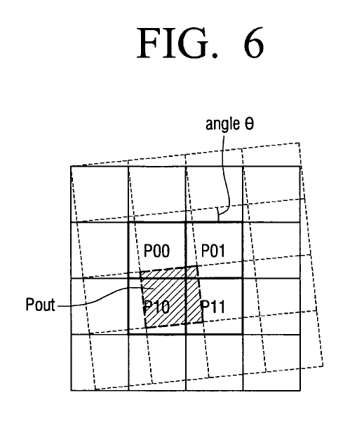

FIG. 6 illustrates the operation of the interpolating unit 174.

Referring to FIG. 6, although position of each pixel is corrected by the image rotating unit 172, it is still necessary to interpolate the lightness values, since there exist differences of lightness values between the pixels before and after the skew occurrence.

The interpolating unit 174 may apply interpolation methods such as nearest neighbor interpolation, linear interpolation, cubic spline interpolation, or the like.

The coordinates of the pixel rotated by mathematical formula 1 is computed by trigonometric function. Accordingly, since the coordinates are real numbers rather than integers, the following mathematical formula 2 is used to interpolate with respect to values below the decimal point:

value=p₀₀*(1−Δx)*(1−Δy)+p₀₁*Δx*(1−Δy)+p₁₀*(1−Δx)*Δy+p₁₁*Δx*Δy

where, Δx represents anything below decimal point of x_{new}, and Δy represents anything below decimal point of y_{new}.

By way of example, as illustrated in FIG. 6, after linear interpolation with respect to pixels P₀₀, P₀₁, P₁₀, P₁₁, an output Pₒᵤₜ may be produced. Although the linear interpolation is carried out with respect to 4×4 size pixel area in FIG. 6, interpolation of lightness values may be performed with increased accuracy, if the size of the pixel area increases.

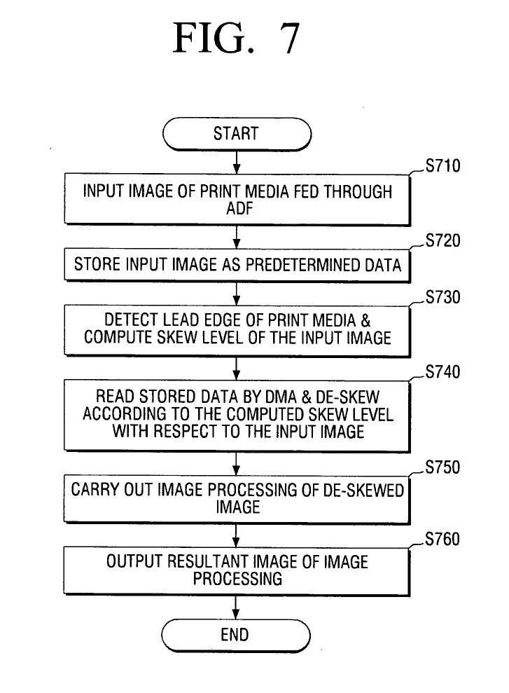

FIG. 7 is a flowchart illustrating a de-skew method of an image forming apparatus according to an embodiment.

Referring to FIG. 7, at S710, the input unit 110 receives an image of a print media fed through the ADF.

At S720, the first storage unit 140 stores the input image in the form of predetermined data.

At S730, the computing unit 150 detects a lead edge of the pint media to compute a skew level of the input image.

At S740, the skew correcting unit 170 reads the stored data through DMA processing, and carries out de-skewing with respect to the input image according to the computed skew level.

At S750, the image processing unit 180 processes the de-skewed image.

At S760, the output unit 190 outputs the resultant image of the image processing.

The operation S740 of carrying out de-skewing may include reducing a burst unit if the computed skew level exceeds a reference value.

The operation S720 of storing may include the operation of storing the input image in a burst unit of data, and the operation S740 of carrying out de-skewing may include the steps of adjusting the burst unit based on the computed skew level and reading the stored data in the adjusted burst unit through the DMA processing.

Accordingly, with a method for de-skewing of an image forming apparatus according to an embodiment, it is possible to adjust the burst unit of data based on the computed skew level, and read the stored data in the adjusted burst unit through the DMA processing. As a result, skew is corrected efficiently.

Additionally, since operation S740 includes correcting a skew with respect to a contone image and performing image processing with respect to the skew-corrected image, image degradation is avoided.

Any repetitious explanations will be omitted as much as possible for the sake of brevity.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus, comprising:
an input unit to receive an image of a print media fed through an automatic document feeder (ADF);
a first storage unit to store the input image as predetermined data form;
a computing unit to detect a lead edge of the print media and compute a skew level of the input image;
a skew correcting unit to read the stored data through a direct memory access (DMA) processing, and carry out de-skewing with respect to the input image according to the computed skew level;
an image processing unit to carry out image processing with respect to the de-skewed image; and
an output unit to output the resultant image of the image processing.

2. The image forming apparatus of claim 1, wherein the first storage unit stores the input image in a burst unit of data, and the skew correcting unit adjusts the burst unit based on the computed skew level and reads the stored data based on the adjusted burst unit through the DMA processing.

3. The image forming apparatus of claim 2, wherein the skew correcting unit reduces the burst unit if the computed skew level exceeds a reference value.

4. The image forming apparatus of claim 2, wherein the skew correcting unit comprises:
an image rotating unit to adjust the burst unit based on the computed skew level, reads the stored data in the adjusted burst unit through the DMA processing, and rotate the image; and
an interpolating unit to interpolate difference of lightness values occurring due to rotating of the image, with respect to each of the pixels constituting the rotated image.

5. The image forming apparatus of claim 1, wherein the input image is a contone image, and the skew correcting unit carries out de-skewing with respect to the contone image.

6. The image forming apparatus of claim 1, wherein the first storage unit is a dynamic random access memory (DRAM).

7. The image forming apparatus of claim 1, further comprising a shading correcting unit to correct a difference of lightness values of the input image in a primary scanning direction; and
a gamma correcting unit to linearly corrects the image of which difference of lightness values is corrected.

8. The image forming apparatus of claim 1, further comprising a second storage unit to store data about the computed skew level, wherein the skew correcting unit carries out de-skewing using the data about the skew level stored in the second storage unit.

9. A method of de-skewing of an image forming apparatus, the method comprising:
receiving an image of a print media fed through an automatic document feeder (ADF);
storing the input image as predetermined data form;
detecting a lead edge of the print media and computing a skew level of the input image;
reading the stored data through a direct memory access (DMA) processing, and carrying out de-skewing with respect to the input image according to the computed skew level;
carrying out image processing with respect to the de-skewed image; and
outputting the resultant image of the image processing.

10. The method of claim 9, wherein the storing comprises storing the input image in a burst unit of data, and the reading the stored data through DMA processing and carrying out de-skewing comprises adjusting the burst unit of the data based on the computed skew level and reading the stored data in the adjusted burst unit through the DMA processing.

11. The method of claim 10, wherein the reading the stored data through DMA processing and carrying out de-skewing comprises reducing the burst unit if the computed skew level exceeds a reference value.

12. The method of claim 10, wherein the reading the stored data through DMA processing and carrying out de-skewing comprises:
adjusting the burst unit based on the computed skew level, reading the stored data in the adjusted burst unit through the DMA processing, and rotating the image; and
interpolating difference of lightness values occurring due to rotating of the image, with respect to each of the pixels constituting the rotated image.

13. The method of claim 9, wherein the input image is a contone image, and the reading the stored data through DMA processing and carrying out de-skewing comprises carrying out de-skewing with respect to the contone image.

14. The method of claim 9, further comprising:
correcting a difference of lightness value of the input image in a primary scanning direction; and
linearly correcting the image of which difference of lightness values is corrected.

15. The method of claim 9, further comprising storing data about the computed skew level, wherein the reading the stored data through DMA processing and carrying out de-skewing comprises carrying out de-skewing using the stored data about the skew level.

16. An image forming apparatus, comprising:
a scanning unit to scan an image of a print media fed through an automatic document feeder (ADF);
a memory to store the input image in a burst unit of data;
a processor to read the stored data through a direct memory access (DMA) processing, carry out de-skewing with respect to the input image according to the computed skew level, and carry out image processing with respect to the de-skewed image; and
a printing unit to output the resultant image of the image processing.

17. The image forming apparatus of claim 16, wherein the memory stores the input image in the burst unit of data, and the processor adjusts the burst unit of the data based on the computed skew level, and reads the stored data based on the adjusted burst unit through the DMA processing.

18. The image forming apparatus of claim 16, wherein the memory is a dynamic random access memory (DRAM) located outside the processor.

19. The image forming apparatus of claim 18, wherein the memory operates to store or read the data of the input image in the predetermined burst unit according to the operating frequency of the DRAM.
